(19) United States
(12) Patent Application Publication
(10) Pub. No.: US 2019/0322331 A1
(43) Pub. Date: Oct. 24, 2019

(54) Quick Clip

(71) Applicant: William Leonard, Tiny (CA)

(72) Inventor: William Leonard, Tiny (CA)

(21) Appl. No.: 15/958,232

(22) Filed: Apr. 20, 2018

(51) Int. Cl. B62K 21/24; B62K 23/02; B62J 6/00; B62K 11/14; B62J 6/16; B62J 6/18

(52) U.S. Cl. CPC B62K 21/24; B62K 23/02; B62J 6/005; B62K 21/26; B62J 6/16; B62J 6/18; B62K 11/14

(57) ABSTRACT

A quick connect handlebar assembly for a motorcycle is disclosed. The handlebar assembly consists of an elongated handlebar having a plurality of motorcycle control components pre-mounted thereto, including indicator lights, throttle controls, gear change controls, turn signal controls and the like. A riser is mounted to a hub portion of the handlebar assembly which is mountable to the riser mount of the motorcycle by a pair of elongated bolts. A plurality of control cables and wires extend from the various motorcycle control components mounted on the handlebar assembly through the handlebar and out of the hub portion. The handlebar assembly is configured to be quickly attached or removed from the motorcycle by means of the elongated pair of elongated bolts.

### FIELD OF THE INVENTION

The present invention generally relates to handlebars and handlebar risers for use with motorcycles.

### BACKGROUND OF THE INVENTION

Motorcycles are a popular mode of transportation. The posture of how a rider rides a motorcycle is controlled by many factors, including the style and height of the handlebars. Standard handlebars are connected to the front fork of the motorcycle by a handlebar riser. The position of the handlebars can be selected by, in part, selecting the size of the riser. The longer the riser, the higher up the handlebars will be positioned and, consequently, the higher the user's hands will be placed when he/she grips the handlebars. However, the style of the handlebars also plays a significant role in how the rider is situated on the motorcycle. Long swept back handlebars permit the rider to sit further back which his/her hands at a higher position. Changing the riding posture therefore can involve changing the handlebars and changing the riser. Changing the handlebars can be highly complicated because of all of the necessary equipment mounted to the handlebars. In particular, critical components such as the side mirrors, brake levers, clutch levers, grips, throttle, clutch cable connectors, throttle cable connectors, break master cylinder, turn signal indicator lights, turn signal switches, and potentially other parts. Therefore, replacing the handlebar of a motorcycle requires a considerable amount of effort because in addition to dismantling the riser and handlebar, all of the components mounted to the handlebar must be disassembled on put on the replacement handlebar. This is a laborious and time consuming task.

The present invention is directed at a solution to this problem.

### SUMMARY OF THE INVENTION

In accordance with one aspect of the present invention, there is provided a quick connect handlebar assembly for use with a motorcycle having a front fork with a riser mount. The quick connect handlebar assembly consists of an elongated handlebar having opposite left and right ends and a hub positioned midway between the opposite left and right ends. A riser is mounted to the hub, the riser being adapted to mount to the riser mount by a pair of elongated bolts. The handlebar assembly further includes a handlebar grip at each end of the handlebar, a throttle control at one end of the handlebar, turn signal indicator switches on one end of the handlebar, left and right turn indicator lights attached to the left and right ends of the handlebar, respectively, and a throttle cable having opposite first and second ends extending through the handlebar between the throttle control and the hub portion. The first end of the throttle cable is coupled to the throttle control and the second end of the throttle control cable extends out of the hub portion. The handlebar assembly further includes an indicator cable extending through the handlebar from the turn signal indicator switches to the hub portion, the indictor control cable having an end extending out of the hub portion. The handlebar assembly further includes an indicator light power cord extending from each of the indicator lights, through the handlebar and to the hub portion, the indicator light power cord having an end extending out of the hub portion. The ends of the throttle cable, indicator cable and indicator light power cable all have quick connect electrical mounting elements. The riser is configured to couple securely to the riser mount of the front fork by two elongated bolts. The two elongated bolts and the riser mount being configured such that the handlebar assembly can be quickly connected or disconnected to the front fork by simply attaching or detaching the two elongated bolts from the riser mount.

With the foregoing in view, and other advantages as will become apparent to those skilled in the art to which this invention relates as this specification proceeds, the invention is herein described by reference to the accompanying drawings forming a part hereof; which includes a description of the preferred typical embodiment of the principles of the present invention.

### DESCRIPTION OF THE DRAWINGS

FIG. 1 is a perspective view of a motorcycle having a handlebar assembly made in accordance with the present invention.

FIG. 2 is a side view of a motorcycle having a handlebar assembly made in accordance with the present invention.

FIG. 3 is a perspective view of a preferred embodiment of the handlebar assembly made in accordance with the present invention.

FIG. 4 is a perspective view of another preferred embodiment of the handlebar assembly made in accordance with the present invention.

In the drawings like characters of reference indicate corresponding parts in the different figures.

### DETAILED DESCRIPTION OF THE INVENTION

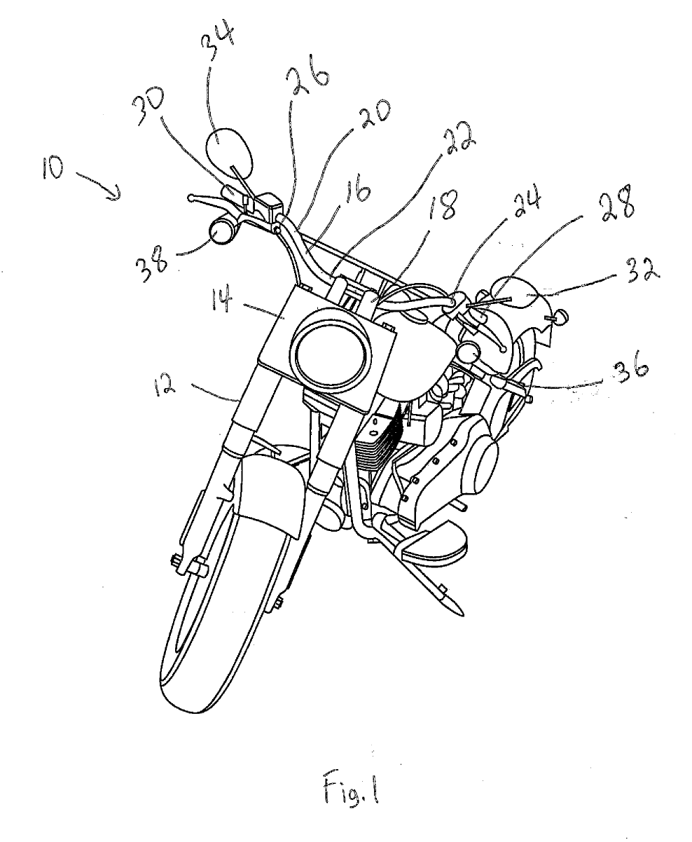

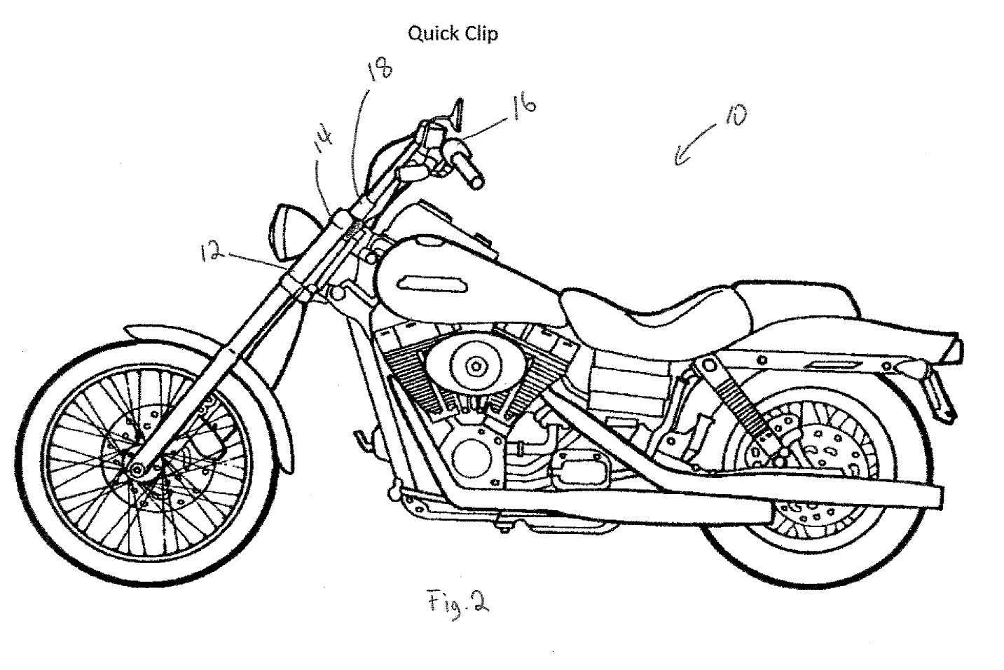

Referring to FIGS. 1 and 2, a motorcycle having a quick connect handlebar assembly is shown generally as item 10 and includes a front fork 12, a riser mount 14 (which is also often called a triple tree or top triple tree), a handlebar assembly 16, and a riser 18 mounted to the riser mount. As seen in FIG. 1, handlebar assembly 16 includes an elongated handlebar 20 having opposite ends 24 and 26 and a central hub portion 22. Central hub portion 22 is mounted to riser 18. Handgrips 28 and 30, mirrors 32 and 34 and turn signal indicators 36 and 38 are mounted to ends 24 and 26, respectively. Other components such as throttle controls, break levers, gear changers and turn signal switches are also mounted to ends 24 and 26 of the elongated handlebar. A plurality of cables and wires extend from the ends of the elongated handlebar to the rest of the motorcycle to provide for electric power to operate the turn signal indicators, the throttle, the gear changes, and other operational and safety features of the motorcycle.

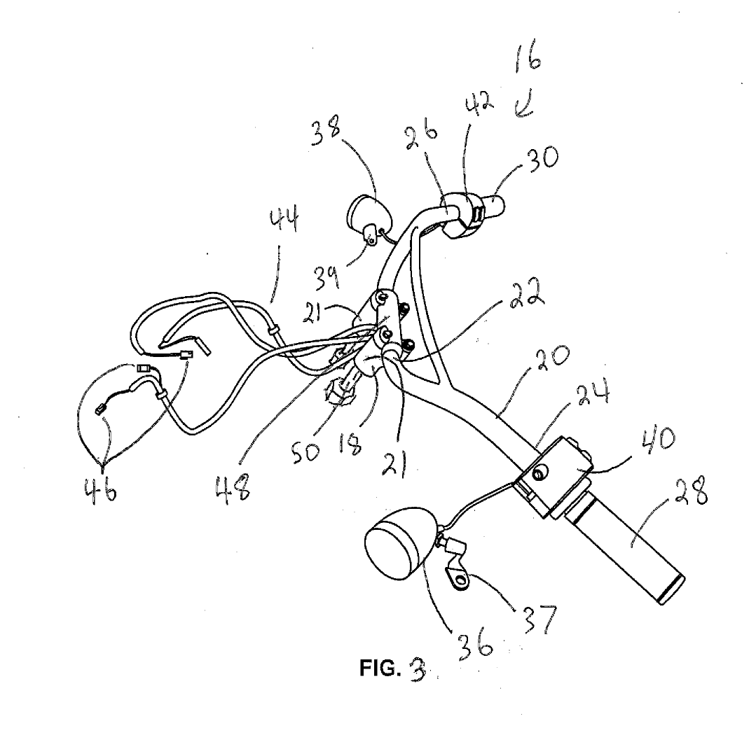

Referring now to FIG. 3, the quick connect handlebar assembly made in accordance with the present invention is shown generally as item 16. Quick connect handlebar assembly 16 is identical to the one illustrated in FIG. 1 and includes the elongated handlebar 20 made of tubular steel. Handlebar 20 has opposite ends 24 and 26 and a central hub portion 22 positioned directly between the opposite ends. Riser 18 includes a clamp portion 48 which is configured to contain and secure hub 22 of handlebar 20. Elongated bolts 50 extend from riser 18 to permit the riser to be quickly connected or disconnected from riser mount 14 (see FIGS. 1 and 2). Handgrips 28 and 30 are mounted to ends 24 and 26, respectively. Handgrips 28 and 30 can be configured to act as throttle controls and or gear shifters as required. The handgrips are pre attached to handlebar 20 including any required cables (not shown). Likewise, the handgrip portion on the right side of the handlebar assembly will have a brake lever (not shown) which is coupled to the rest of the motorcycle by an elongated brake cable (not shown). The cables for the brake lever and the throttle control are preferably adjustable so that their lengths can be adjusted to ensure they coordinate well with the rest of the motorcycle and do not interfere with the operation of the motorcycle. Control units 40 and 42 are likewise attached to ends 24 and 26, respectively. These control units control the operation of turn signal indicators, headlamp operation, and other motorcycle related operations and equipment. The cables used in conjunction with control units 40 and 42 can be run through handlebar 20. Turn signal indicators 36 and 38 are pre-wired to handlebar 20 and can be secured in place by brackets 37 and 39, respectively. The cables and wires necessary for the operation of the throttle, gear changers, control units and turn signal indicators for a bundle of cables 44 which project out of hub portion 22 of handlebar 20. The ends of the bundle of cables are provided with quick connector elements 46 making for quick connection to electrical cables and components on the rest of the motor cycle.

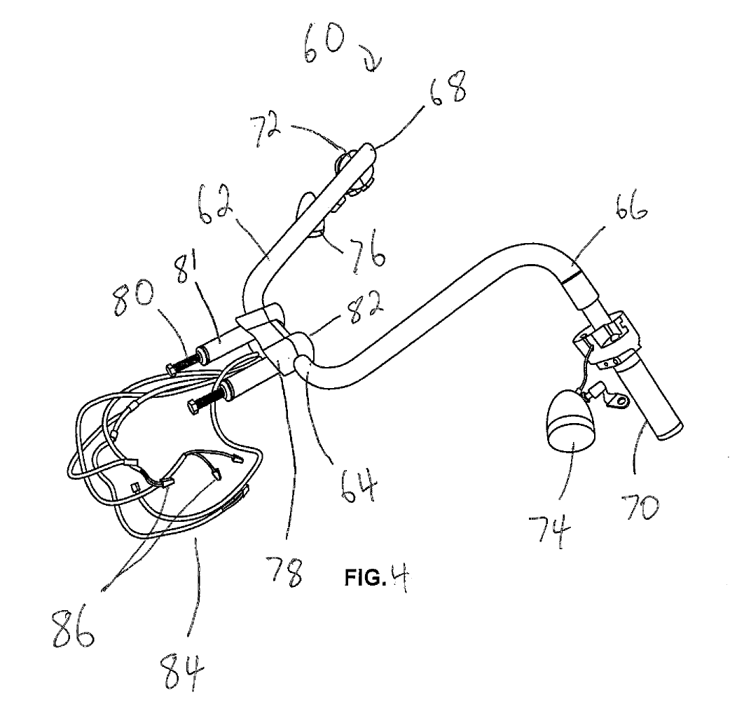

Referring now to FIG. 4, an alternate quick connect handlebar assembly is shown generally as item 60 and, as in the previous embodiment, includes an elongated handlebar 62 having hub portion 64 and opposite ends 66 and 68. Handgrips 70 and 72 are positioned on ends 66 and 68 respectively, as in the previous embodiment. Handlebar 62 is a very different shape than the corresponding handlebar of the previous embodiment. Handlebar 62 positions ends 66 and 68 much higher relative to riser 78 and hub 64 resulting in a very different ride configuration when the handlebar assembly is mounted to the motorcycle. The other components of the handlebar assembly discussed with reference to the previous embodiment are reproduced exactly on handlebar assembly 60 including the turn signal indicators 74 and 76. For the purposes of the present description, the other components such as the control units, mirrors and the like are not illustrated, but it will be appreciated that other than the shape of handlebar 62, the various components are identical between the embodiments shown in FIGS. 3 and 4. As in the previous embodiment, a bundle of cables 84 projects out of hub portion 64 and each of the cables is likewise provided with quick connector elements 86. Riser 78 securely attaches to hub portion 64 by cap 82. Elongated bolts 80 extend from riser 78 for quick connection to the riser mount on the motorcycle. Elongated bolts 80 of handlebar assembly 60 are identical to and compatible with elongated bolts 50 of handlebar assembly 16 shown in FIG. 3, permitting the handlebar assemblies to be quickly swapped out one for the other on a motorcycle without the need for detaching and reattaching the various handlebar assembly components. As with the previous embodiment, handlebar assembly 60 will have a throttle (not shown) and a brake lever (not shown), both usually located on the right side. Both the throttle and the brake lever will be coupled to the rest of the motorcycle by an elongated throttle cable and brake cable. As in the previous embodiment, the throttle cable and brake cable are preferably adjustable so that their lengths can be extended or shortened as required to ensure that the cables are long enough to extend between the end of the handle bar assembly 60 and the motorcycle but is not so long as to interfere with the operation of the motor cycle.

The present invention permits the user to quickly and easily change the ride profile of a motorcycle simply by swapping out the handlebar assembly. By simply loosening the elongated attachment bolts 50 (FIG. 3) from riser mount 14 (FIGS. 1 and 2), handlebar assembly 16 can be removed. The cables coupled to the handlebar assembly can then be quickly dethatched without the need for cutting by virtue of the quick connect coupling elements. Handlebar assembly 16 can thus be removed from the motorcycle quickly and easily without the need for special tools or particular expertise. Ordinary wrenches, screw drivers and pliers are all the tools required to swap between handlebar assemblies 16 (FIG. 3) and 60 (FIG. 4) in less than an hour. The operation is so simple and easy that the owner of the motorcycle can perform the swap themselves without requiring the motorcycle to be sent in for service. Handlebar assembly 60 (FIG. 4) can then be attached to the motorcycle by attaching elongated bolts 80 to riser mount 14 (FIGS. 1 and 2) and reattaching the cables and wires using the quick connect elements. The time and labor required to swap out the various components of the handlebar assembly is therefore saved, making the transformation of the motorcycle easy, quick and safe. It is possible to provide an inventory of different preassembled handlebar assemblies having handlebars of different shapes and configurations, permitting users to quickly change the ride orientation of their motorcycle as required.

The present invention has several compelling features which makes it a desirable improvement over existing motorcycle handlebars. Firstly, the components of each of the handlebar assemblies are identical stock components as found on the stock motorcycle for the model and make of the bike. This permits the user to switch between the handlebars without sacrificing the quality and usability of standard components. Handlebar assemblies 16 (FIG. 3) and 60 (FIG. 4) both look like stock motorcycle handlebar assemblies, and not “custom” or third party options.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A quick connect handlebar assembly for use with a motorcycle having a front fork with a riser mount, the quick connect handlebar assembly comprising an elongated handlebar having opposite left and right ends and a hub positioned midway between the opposite left and right ends, a riser mounted to the hub, the riser adapted to mount to the riser mount by a pair of elongated bolts, the handlebar assembly further comprising a handlebar grip at each end of the handlebar, a throttle control at one end of the handlebar, turn signal indicator switches on one end of the handlebar, left and right turn indicator lights attached to the left and right ends of the handlebar, respectively, a throttle cable having opposite first and second ends extending through the handlebar between the throttle control and the hub portion, the first end of the throttle cable being coupled to the throttle control, the second end of the throttle control cable extending out of the hub portion, an indicator cable extending through the handlebar from the turn signal indicator switches to the hub portion, the indictor control cable having an end extending out of the hub portion, an indicator light power cord extending from each of the indicator lights, through the handlebar and to the hub portion, the indicator light power cord having an end extending out of the hub portion, the ends of the throttle cable, indicator cable and indicator light power cable all having quick connect electrical mounting elements, the riser being configured to couple securely to the riser mount of the front fork by two elongated bolts.
